(19) United States
(12) Patent Application Publication
(10) Pub. No.: US 2017/0086440 A1
(43) Pub. Date: Mar. 30, 2017

(54) NONELECTRIC AERATED BAIT BUCKET

(71) Applicant: VIA-FRY, LLC, North Port, FL (US)

(72) Inventor: Arthur B. VIA, JR., Port Charlotte, FL (US)

(21) Appl. No.: 15/275,956

(22) Filed: Sep. 26, 2016

Related U.S. Application Data
(60) Provisional application No. 62/232,698, filed on Sep. 25, 2015.

(51) Int. Cl. A01K 97/05

(52) U.S. Cl. CPC A01K 97/05

(57) ABSTRACT

A nonelectric aerated bait bucket includes an outer casing housing a bait compartment. The bait compartment is configured to hold water and live bait. The bait bucket also includes a bait retrieval door disposed on a top of the bait compartment, an air canister coupled to the outer casing configured to hold compressed air, and an air hose. In addition, the bait bucket includes a regulator coupled between the air canister and the air hose. The regulator is configured to provide a controlled release of compressed air from the air canister to the bait compartment via the air hose in an amount required to aerate the water for the live bait contained therein without using electrical power.

### FIELD

The present invention is related to bait buckets, and, more particularly, to a nonelectric aerated bait bucket configured to keep live bait therein alive for extended periods of time.

### BACKGROUND

Typical bait buckets are filled with water so that live bait, such as minnows, can be placed in the water and transported within the bait bucket. In order to keep the live bait alive and fresh within the bait bucket, the water in the bait bucket must be aerated. Otherwise, after a relatively short time period, the live bait will die and must be thrown out. Thus, some bait buckets have attempted to address this problem by including an electric pump that is used to aerate and provide air to the water. The electric pumps are powered by batteries or by other electrical sources. The electric pumps can be expensive and also may be susceptible to breaking down and becoming inoperative at the most inopportune times. Accordingly, this leaves the fisherman with no way to aerate the water in the bait bucket when out fishing in remote areas and reduces the time period that the live bait remains usable.

The live bait is generally either purchased from a bait store or can be caught by the fisherman through his or her own efforts. With either alternative, the fisherman loses money and resources when the live bait dies. In addition, the use of electric pumps may create a dangerous situation around the bait bucket due to the water and the possibility of creating a short. In addition, if the aeration pump is powered by batteries and the batteries die, the fisherman has no ability to aerate the water in the bait bucket.

### SUMMARY

In view of the foregoing background, it is therefore an object of the present invention to provide a live bait bucket that is rugged and does not rely on electrical power or electric pumps to aerate the water within the bait bucket. This and other objects, features, and advantages in accordance with the present invention are provided by a nonelectric aerated bait bucket that includes an outer casing housing a bait compartment. The bait compartment is configured to hold water and live bait. The bait bucket also includes a bait retrieval door disposed on a top of the bait compartment, an air canister coupled to the outer casing configured to hold compressed air, and an air hose. In addition, the bait bucket includes a regulator coupled between the air canister and the air hose. The regulator is configured to provide a controlled release of compressed air from the air canister to the bait compartment via the air hose in an amount required to aerate the water for the live bait contained therein without using electrical power.

In another embodiment, a nonelectric aerated bait bucket includes an outer casing housing a bait compartment, and a bait retrieval door disposed on a top of the bait compartment. In addition, the bait bucket includes an air canister coupled to the outer casing and configured to hold compressed air. The bait bucket also includes an air hose and a regulator coupled between the air container and the air hose. The regulator is configured to expand the compressed air leaving the air canister in order to reduce a temperature of air provided to the bait compartment via the air hose. A valve gauge is coupled to the air canister and configured to adjust a flow of air from the air canister to the bait compartment.

### BRIEF DESCRIPTION OF THE DRAWINGS

FIG. 1 is a front elevational view of a nonelectric aerated bait bucket in accordance with an embodiment of the present invention;

FIG. 2 is a right side elevational view of the nonelectric aerated bait bucket taken in the direction of line 2-2 of FIG. 1;

FIG. 3 is a top view of the nonelectric aerated bait bucket taken in the direction of line 3-3 of FIG. 1;

FIG. 4 is a rear view of the nonelectric aerated bait bucket taken in the direction of line 4-4 of FIG. 2;

FIG. 5 is a cross sectional view of the nonelectric aerated bait bucket taken along the line 5-5 of FIG. 1; and

FIG. 6 is a partial cross sectional view of the nonelectric bait bucket taken along the line 6-6 of FIG. 1.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention may store compressed air which may then mechanically be delivered to the water periodically to oxygenate the water. This keeps the bait alive longer, without the need for external electrical power. The present invention saves money and resources, and because it does not require external electric power, it may be used in remote areas for a number of fish related industries.

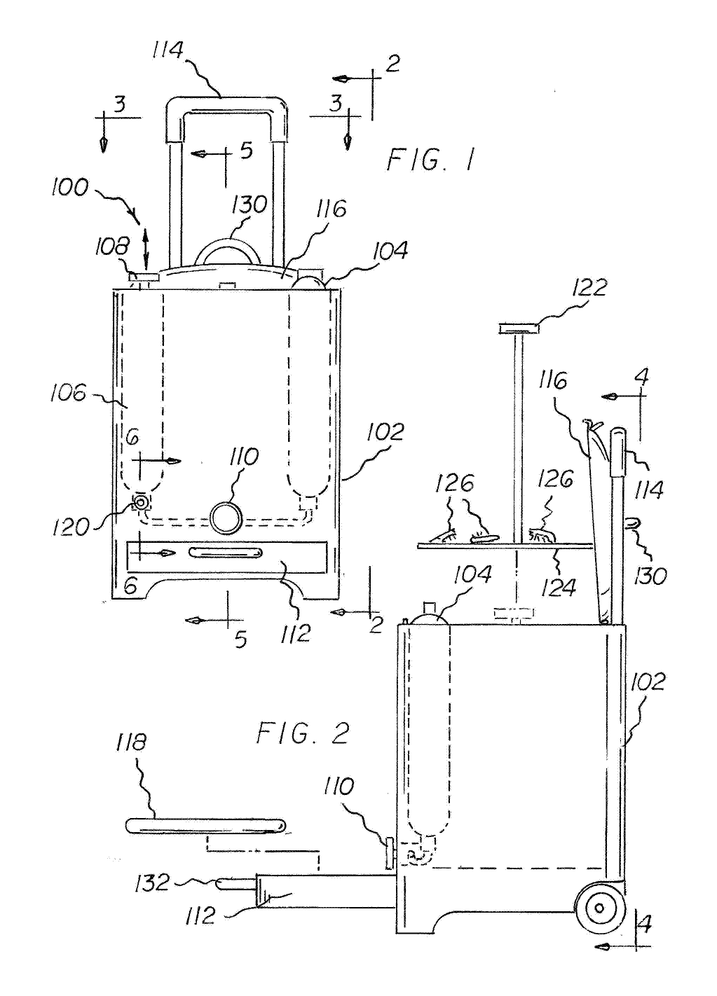

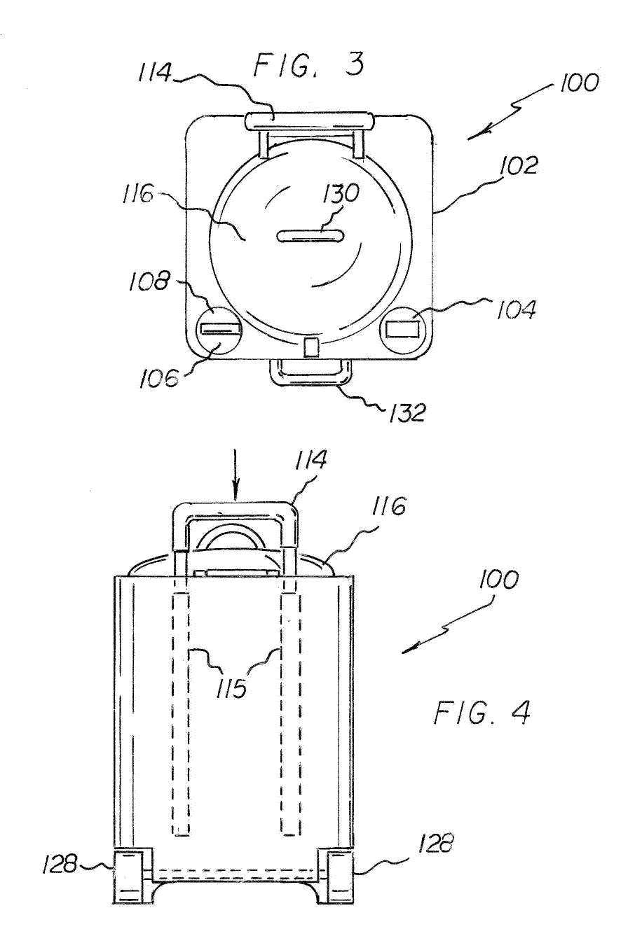

Referring now to FIGS. 1-6, the nonelectric aerated bait bucket 100 has an outer casing 102 housing a bait compartment 140. The bait compartment 140 is configured to hold water and live bait 126. A bait retrieval door 116 is disposed on a top of the bait compartment 140.

In certain embodiments, the outer casing 102 may comprise molded polymers, such as plastic. A first air canister 104 and a second air canister 106 may be secured proximate a front portion of the outer casing 102 and are configured to hold compressed air. In addition, a manual pump 108 may be included with either of the first 104 and second air canisters 106 and be configured to provide the compressed air to the air canisters 104 and 106.

A regulator 134 is coupled between the air canisters 104 and 106 and an air hose 135. The regulator 134 is configured to provide a controlled release of compressed air from the air canisters 104 and 106 to an outlet 136 in the bait compartment 140 via the air hose 135 in an amount required to aerate the water for the live bait 126 without using electrical power.

A telescoping handle 114 may be coupled to the outer casing 102 and configured to extend up from slide pockets 115 of the outer casing 102. The telescoping handle 114 is configured to be grasped by a hand of a user. A plurality of wheels 128 may be coupled to a lower outer portion of the outer casing 102 and used to assist in transporting the bait bucket 100 by rolling.

A refilling port 120 is accessible from the outside of the outer casing 102 and is coupled to the air canisters 104 and 106. The refilling port 120 is configured to receive pressurized air from a compressor, for example, to store within the air canisters 104 and 106.

A valve gauge 110 is in fluid communication with the air canisters 104 and 106 and is configured to provide a desired flow rate or volume of the compressed air being released from the air canisters 104 and 106 to the bait compartment 140. The valve gauge 110 is also configured to adjust a flow of the compressed air from the air canister 104 to the bait compartment 140.

Although two air canisters 104 are shown in this particular exemplary embodiment of the invention, only one air canister may be included with the bait bucket 100, or two or more air canisters could be used and is considered to be within the scope of the present nonelectric aerated bait bucket 100.

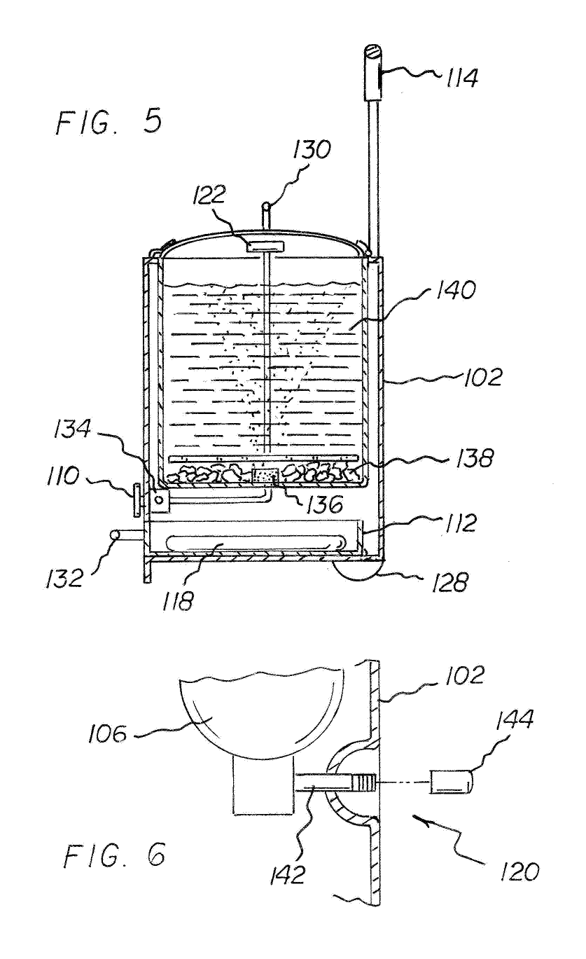

In certain embodiments, the bait compartment 140 may comprise molded polymers, such as plastic and similar to the outer casing 102. Bait may be retrieved by grasping handle 130 and opening the bait retrieval door 116. A bait retrieval lift 121 is used to lift up the bait 126 to the surface of the water in the bait compartment 140. The bait retrieval lift 121 includes an elongated handle 122 and a perforated planar element 124 connected to a distal end of the elongated handle 122 and is configured to lay adjacent to a bottom of the bait compartment 140. A plurality of porous rocks 138 may be placed on a bottom of the bait compartment 140 as shown in FIG. 5.

The bait bucket 100 may include a tray 112 below the bottom of the bait compartment 140 and configured to be pulled out by a handle 132 and filled with ice to cool the bait compartment 140. The tray 112 may house a freezer pack 118, for example, to keep the water temperature around sixty degrees Fahrenheit, making the bait energetic and requiring less oxygen to keep them alive.

The refilling port 120 includes an air stem 142 coupled to the air canister 106 and is configured to connect to an air hose to fill the air canister 106 with compressed air. A cap 144 may be placed over the air stem 142 when not in use. The bait bucket is configured to withstand between 100 and 180 psi.

The components may be arranged to make the best use of space, so that the air canisters 104,106 and all components necessary for the nonelectric aerated bait bucket 100 to function properly may be accomplished without electrical power. In another embodiment, the components may be used at a much larger scale to transport larger fish/marine life over long distances and in remote areas. In addition, the components may be manipulated and conformed to fit into an ordinary five gallon bait bucket.

In operation of the nonelectric aerated bait bucket 100, at least one of the air canisters 104 and/or 106 is filled with compressed air. The regulator 134 is adjustable and configured to release air at a given flow rate depending on what may be transported. The compressed air may be available for multiple hours without having to compress more air. The bait compartment 140 is filled with water, the freezer pack 118 is placed in the tray 112, the bait 126 is placed through the bait retrieval door 116 into the bait compartment 140, and the regulator 134 is turned on to start the air flow to the bait compartment 140. In addition, the regulator 134 is configured to release the compressed air from the air canisters 104 and 106 to cool the water within the bait bucket. The release of compressed air from the air canisters 104 and 106 using the regulator 134 causes the air to expand and cool before it is discharged into the water of the bait bucket 140. This in contrast to an electric air pump that pumps ambient air. To collect the bait 126 from the bait compartment 140, the user opens the bait retrieval door 116 and uses the bait retrieval lift 121 to capture bait 126.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A nonelectric aerated bait bucket comprising:
an outer casing housing a bait compartment, the bait compartment configured to hold water and live bait;
a bait retrieval door disposed on a top of the bait compartment;
an air canister coupled to the outer casing and configured to hold compressed air;
an air hose; and
a regulator coupled between the air canister and the air hose, the regulator configured to provide a controlled release of compressed air from the air canister to the bait compartment via the air hose in an amount required to aerate the water for the live bait contained therein without using electrical power.

2. The nonelectric aerated bait bucket of claim 1, further comprising a manual hand pump in fluid communication with the air canister, the manual hand pump configured to provide the compressed air to the air canister.

3. The nonelectric aerated bait bucket of claim 1, further comprising a tray below the bottom of the bait compartment and configured to be pulled out and filled with ice to cool the bait compartment.

4. The nonelectric aerated bait bucket of claim 1, further comprising a bait retrieval lifter placed within the bait compartment, wherein the bait retrieval lifter comprises an elongated handle and a perforated planar element connected to a distal end of the elongated handle and configured to lay adjacent to a bottom of the bait compartment.

5. The nonelectric aerated bait bucket of claim 1, further comprising a telescoping handle coupled to the outer casing and configured to extend up from the outer casing to be grasped by a hand of a user.

6. The nonelectric aerated bait bucket of claim 1, further comprising a plurality of wheels coupled to a lower outer portion of the outer casing.

7. The nonelectric aerated bait bucket of claim 1, further comprising a refilling port coupled to the air canister and configured to receive pressurized air to store within the air canister.

8. The nonelectric aerated bait bucket of claim 1, further comprising a valve gauge coupled to the air canister and configured to provide a flow rate or volume of the compressed air being released from the air canister to the bait compartment.

9. The nonelectric aerated bait bucket of claim 1, further comprising a plurality of porous rocks placed on a bottom of the bait compartment.

10. The nonelectric aerated bait bucket of claim 1, further comprising a valve gauge coupled to the air canister and configured to adjust a flow of the compressed air from the air canister to the bait compartment.

11. The nonelectric aerated bait bucket of claim 7, wherein the refilling port comprises an air stem coupled to the air canister and configured to connect to an air hose to fill the air canister with compressed air.

12. A nonelectric aerated bait bucket comprising:
an outer casing housing a bait compartment;
a bait retrieval door disposed on a top of the bait compartment;
an air canister coupled to the outer casing and configured to hold compressed air;
an air hose;
a regulator coupled between the air container and the air hose, the regulator configured to provide a controlled release of air from the air canister to the bait compartment via the air hose without using electrical power;
a valve gauge coupled to the air canister and configured to provide a flow rate or volume of air being released from the air canister to the bait compartment, and to adjust a flow of air from the air canister to the bait compartment.

13. The nonelectric aerated bait bucket of claim 12, further comprising a manual hand pump in fluid communication with the air canister, the manual hand pump configured to provide compressed air to the air canister.

14. The nonelectric aerated bait bucket of claim 12, further comprising a tray below the bottom of the bait compartment and configured to be pulled out and filled with ice to cool the bait compartment.

15. The nonelectric aerated bait bucket of claim 12, further comprising a bait retrieval lifter placed within the inner bait compartment, the bait retrieval lifter comprises an elongated handle and a perforated planar element connected to a distal end.

16. The nonelectric aerated bait bucket of claim 12, further comprising a telescoping handle coupled to the outer casing and configured to extend up from the outer casing to be grasped by a hand of a user.

16. The nonelectric aerated bait bucket of claim 12, further comprising a plurality of wheels coupled to a lower outer portion of the outer casing.

17. The nonelectric aerated bait bucket of claim 12, further comprising a refilling port coupled to the air canister and configured to receive pressurized air to store within the air canister.

18. The nonelectric aerated bait bucket of claim 12, further comprising an aerating rock coupled to a distal end of the air hose and configured to disburse air within the bait compartment.

19. The nonelectric aerated bait bucket of claim 17, wherein the refilling port comprises an air stem coupled to the air canister and configured to connect to an air hose to fill the air canister with compressed air.

20. A nonelectric aerated bait bucket comprising:
an outer casing housing a bait compartment;
a bait retrieval door disposed on a top of the bait compartment;
an air canister coupled to the outer casing and configured to hold compressed air;
an air hose;
a regulator coupled between the air container and the air hose and configured to expand the compressed air leaving the air canister in order to reduce a temperature of air provided to the bait compartment via the air hose; and
a valve gauge coupled to the air canister and configured to adjust a flow of air from the air canister to the bait compartment.
